(19) United States
(12) Patent Application Publication
(10) Pub. No.: US 2012/0126052 A1
(43) Pub. Date: May 24, 2012

(54) FLIGHT DEVICE

(76) Inventor: Hideyo Murakami, Fukuoka-shi (JP)

(21) Appl. No.: 13/299,105

(22) Filed: Nov. 17, 2011

(30) Foreign Application Priority Data
Nov. 22, 2010 (JP) 2010-260619

(51) Int. Cl. B64B 1/00

(52) U.S. Cl. 244/25; 244/24

(57) ABSTRACT

Provided is a flight device which can utilize headwind and following wind, respond flexibly to changes of wind directions and travel stably. The flight device includes a main body with an air sac. It also includes a forward air resistance changing unit and a backward air resistance changing unit that lies anterior and posterior to the main body in traveling direction, respectively. They are controlled by a controller to change air resistance. As a result, the flight device can travel stably despite wind direction. The flight device further includes a wing tilted vertically which provides driving force without gasoline engine. The driving force is gained from vertical wind caused by changing altitude using air sac. Further, the flight device can select the route toward the destination based on the prediction of changes of winds by prediction device.

### TECHNICAL FIELD

The present invention relates to a flight device, in particular, a flight device with a main body including an air sac.

### BACKGROUND ART

In recent years, transportation systems which emit less carbon dioxide are actively developed from an ecological point of view. As for practically used airships or balloons as well, traveling function without driving force caused by gasoline engine and the like is required from an ecological point of view. In the following, “airstream” means the stream of air relative to the ground. And “wind” means the flow of air relative to flight devices, airships, balloons and the like.

Examples of wind-driven flight devices are described in Patent Documents 1 to 3. In Patent Document 1, a wind-driven balloon with a sail is described. This balloon adjusts the angle of the sail and sails with following wind. It puts in the sail in case of headwind. In Patent Documents 2 and 3, airships and the like with wings are described.

### PRIOR ART DOCUMENTS

### Patent Documents

Patent Document 1: Japanese Unexamined Patent Application Publication No. H09-207890.
Patent Document 2: Japanese Unexamined Patent Application Publication No. S52-121295.
Patent Document 3: Japanese Unexamined Patent Application Publication No. S57-55297.

### SUMMARY OF THE INVENTION

### Problems to be Solved by the Invention

However, the balloon described in Patent Document 1 only sails with following wind. That is, Patent Document 1 only discloses the driving force caused by the following wind to the sail. The balloon puts in its sail in case of headwind just because the sail does not work.

Even the balloon without its own driving force is desired to move against winds. And when it travels against winds, it has to keep its posture. The sail described in Patent Document 1 is not designed for traveling against winds. Actually, Patent Document 1 only discloses a balloon which effectively drifts with winds.

The airship described in Patent Document 2 travels with its own engine. Such airships with their own driving force basically assume that wind blows from forward traveling direction (headwind). As a result, the shape of the anterior part of the airship is designed just for decreasing wind drag and the posterior part of the airship controls the traveling direction with its tail unit. Accordingly, these airships lose their posture when wind blows from other than forward traveling direction (when receiving a following wind, for example). The air yacht described in Patent Document 3 also basically assumes to receive only headwind.

As described above, conventional wind-driven flight devices have utilized only one direction of winds. For example, the balloon described in Patent Document 1 can gain driving force only from following winds and cannot utilize the other directions of winds. And flight devices described in Patent Document 2 and 3 assume only headwind to their wings. As a result, the conventional flight devices cannot utilize various directions of winds effectively to travel.

Therefore, an object of the present invention is to provide a flight device which can utilize headwind and following wind, respond flexibly to changes of wind directions, and travel stably.

### Means for Solving the Problems

A first aspect in accordance with the present invention provides a flight device with a main body including an air sac, comprising a forward air resistance changing unit that lies anterior to the main body in traveling direction and is controlled by a controller to change air resistance against external air, wherein the controller controls the forward air resistance changing unit, when the external air moves from forward in traveling direction, to stabilize posture by decreasing air resistance in traveling direction, and the controller controls the forward air resistance changing unit, when the external air moves from backward in traveling direction, to stabilize posture as well as to cause driving force by increasing air resistance in traveling direction and functioning as a sail.

A second aspect in accordance with the present invention provides the flight device of the first aspect, wherein the main body includes a wing whose position and/or shape is changed by control of the controller, the controller controls buoyant force caused by the air sac to change altitude, and the controller gives forward driving force to the wing by vertical moving of the external air.

A third aspect in accordance with the present invention provides the flight device of the second aspect, the forward air resistance changing unit includes one or more air resistance member, the controller controls the air resistance member to increase forward air resistance by increasing angle to forward traveling direction and to decrease forward air resistance by decreasing angle to forward traveling direction, and the controller controls the air resistance member also to increase or decrease vertical air resistance.

A fourth aspect in accordance with the present invention provides the flight device of any of the first to third aspects, wherein the main body insulates the air sac from the external air to keep temperature of the air sac and includes an external air gate for letting the external air into the main body, the air sac matches temperature of air inside of the air sac and temperature of the external air let into the main body, and the controller increases or decreases buoyant force by letting external air in the main body through the external air gate at a certain altitude.

A fifth aspect in accordance with the present invention provides the flight device of any of the first to fourth aspects, further comprising a backward air resistance changing unit that lies posterior to the main body in traveling direction and is controlled by the controller to change air resistance against external air, wherein the controller controls the backward air resistance changing unit to stabilize posture as well as to adjust traveling speed by increasing the air resistance, and the controller controls the backward air resistance changing unit to adjust forward traveling direction by changing the balance of right-and-left air resistances in traveling direction.

A sixth aspect in accordance with the present invention provides the flight device of the fifth aspect, wherein the controller controls the backward air resistance changing unit, when the external air moves from forward in traveling direction, to decelerate by increasing air resistance in traveling direction, and the controller controls the backward air resistance changing unit, when the external air moves from backward in traveling direction, to stabilize posture by decreasing air resistance in traveling direction.

A seventh aspect in accordance with the present invention provides the flight device of any of the first to sixth aspects, further comprising a prediction device that predicts relative wind direction of the external air against the flight device based on traveling direction data which indicates traveling direction of the flight device and airstream data which indicates speed and direction of airstream at a spatial point where the flight device flies, wherein the controller controls the forward air resistance changing unit, when the prediction device predicts change of relative wind direction of the external air, to change air resistance.

An eighth aspect in accordance with the present invention provides the flight device of the seventh aspect, wherein the prediction device predicts relative wind direction and relative wind speed of the external air against the flight device in a route from a position and an altitude of a spatial point to a position and an altitude of a destination, and the controller determines a candidate route to a destination by distinguishing relative wind direction of the external air in the route between wind from backward in traveling direction and wind from forward in traveling direction and by analyzing change of traveling speed of the flight device based on changing altitude and on relative wind speed of the external air.

Here, it should be noted that “A and/or B” means either A or B, or both of them regarding to the present invention.

In the present invention, a wing utilizes the lift force from the wind while the flight device moves vertically to gain driving force in horizontal direction. Generally, airplanes and the like utilize the lift force from the wind while the airplanes move horizontally to gain driving force in vertical direction (buoyant force). The wing in the present invention is based on, so to say, the 90-degree change in thinking around spatial axis. When the flight device moves downward, its potential energy of gravity decreases and, from the viewpoint of energy conservation law, the flight device gains the corresponding amount of kinetic energy, that is, driving force. On the other hand, when the flight device moves upward, its potential energy of buoyant force is similarly considered in place of potential energy of gravity. And the flight device gains kinetic energy corresponding to the decrease of potential energy of buoyant force. Here, when the flight device moves horizontally and so on, the wing cause air resistance. Therefore, the controller may control the wing, when moving horizontally and so on, to decrease the air resistance by folding the wing closely along the main body or by putting the wing into the main body.

As for the seventh aspect, the flight device may obtain each data not only by measuring itself, but also by retrieving such data from, for example, a server and the like managed by governmental Meteorological Agency. In addition, the data may be the data obtained by other flight devices or data predicted by servers managed by a private company. The flight device may receive such data with communication devices via Internet and the like.

Further, another aspect of the present invention is a prediction device of the seventh or the eighth aspects. Another aspect of the present invention is a prediction method or a program capable of causing a computer to execute the prediction method or to work as a prediction device. Another aspect of the present invention is a recording medium steadily recording the program so as to be able to cause a computer to execute the program.

### Effects of the Invention

According to each aspect of the present invention, it is possible to stabilize the posture of the whole flight device by changing the air resistance at the forward air resistance changing unit. As a result, because the flight device can utilize headwind and following wind, it can travel stably. In addition, according to the fifth and sixth aspect, it is also possible to keep the posture and speed of the flight device more stably and to adjust traveling direction more easily by adjusting air resistance at the backward air resistance changing unit.

Further, according to the second aspect, it is possible to gain horizontal driving force, even when driving force cannot be obtained from following winds at least by utilizing vertical winds, from vertical kinetic energy based on increase or decrease of buoyant force. It is possible for the flight device to gain driving force at any altitude by transforming its movement upward or downward which results from adjusting buoyant force of air sac into horizontal driving force. Therefore, the flight device can travel stably independently of airstream direction, or even without airstream. In Patent Document 3, it is abstractly described “Forward driving force can be gained by transforming vertical force into force with horizontal component.” However, the air yacht of Patent Document 3 has a long floating body elongated in traveling direction and wings spread out horizontally. So, the vertical buoyant force is decreased by the shapes of its floating body and wings. Therefore, the air yacht of Patent Document 3 assumes, as well as a conventional airship of Patent Document 2, to move forward only. Besides, the air yacht of Patent Document 3 is subjected to such a large air resistance vertical to its wings if buoyant force occurs that the yacht is easy to roll from the loss of drag balance and its posture at a small turbulence. The desirable structure to utilize buoyant force of air sac is vertically-tilted wings to gain driving force, as described in the second aspect of the present invention.

Further, according to the third aspect, it is possible for the flight device to travel easier keeping its posture when, for example, it moves vertically and changes its altitude while there is no wind. In such a case, the controller can decrease the air resistance for moving vertically by controlling the air resistance member to form a sharper angle downward when moving downward and to form a sharper angle upward when moving upward.

Further, according to the fourth aspect, it is possible for the flight device to travel more ecologically by letting external air into inside of main body to adjust buoyant force without using large mechanical force. Here, the main body may keep the external air inside or let the external air out. By exchanging external air like this, the temperature can be easily adjusted.

The sail described in Patent Document 1 is put in while receiving headwind. This is because the sail described in Patent Document 1 is just to ride on winds. That is, the sail of Patent Document 1 is not for utilizing winds at different altitudes and the like after predicting the winds at different time points and positions. It can utilize the observation of only following winds for the balloon at one time point, i.e., at present. However, a flight device can utilize various winds by changing its altitude. Therefore, according to the present invention, the flight device can travel keeping its driving force and its altitude by gaining driving force from following wind at another altitude and by gaining additional driving force using wings when it moves back to its original altitude. According to the present invention, it is also possible to utilize winds of various directions and airstreams at different altitudes.

As described above, according to the present invention, the flight device can control its speed freely and stably and ride smoothly on or off airstreams of various directions and speeds. Therefore, the flight device can travel ecologically at low cost utilizing energy of airstream by changing airstreams (like by changing trains) at different altitudes to approach the destination. For example, if an airstream approaches the destination, it can ride on the airstream to travel. When the direction of the airstream becomes different a lot from the direction toward the destination, it can change its altitude to ride off the airstream utilizing driving force to travel a short distance away. Thereafter, it can select another airstream toward the destination and change its altitude to ride on the airstream. Like this, it can approach the destination by changing airstreams.

Here, it should be notified that the speed and the direction of the wind around the flight device changes from moment to moment. It is necessary to obtain information of the speed and the direction of the wind around the flight device to travel stably to the destination utilizing winds. According to the seventh aspect of the present invention, a prediction device predicts the change of the speed and the direction of winds based on meteorological data, including airstream data, and the controller controls the forward air resistance changing unit to correspond to the change of winds. Therefore, the flight device can travel at high speed and stably.

Further, according to the eighth aspect of the present invention, the prediction device predicts the speeds and the directions of winds in the route toward the destination, including the directions and the speed of the airstreams at altitudes where the flight device is not traveling. Here, the controller analyzes the traveling speed considering additional driving force which is gained by transforming the kinetic energy which occurred based on the change of the altitude of the flight device, as described in the second aspect of the present invention. Therefore, the flight device can travel at higher speed and more stably by selecting an adequate route for a predetermined purpose, such as a route toward the destination, including by changing its altitude.

Here, the prediction device assumes that the information of airstreams at a plurality of points is known or computable based on the meteorological data such as pressure pattern, landscape, clouds and the like. The technology to obtain such information is already established. For example, for over about 7 km above the sea, there are pluralities of globally steady airstreams such as jet stream and, although the flow paths of the airstreams change in the long term, they do not change a lot day by day. For under 7 km above the sea, the speed of the airstreams are slower than about 300 km/hour, their directions and speeds do not change a lot within about an hour. And Meteorological Agency measures airstreams with wind profilers and provides the information via Internet. For less than 3 km above the sea, an airstream of about 36 km/hour (about 10 m/second) almost always exists anywhere within the country.

Therefore, based on the technological level at present, it is possible to obtain the information of airstreams at a plurality of points for estimating information of airstreams at an arbitrary altitude. Thus, the flight device can travel at high speed and stably selecting adequate routes by utilizing the prediction result based on such information.

### BRIEF DESCRIPTION OF DRAWINGS

FIG. 1 is a schematic block diagram of the flight device 1 in accordance with the embodiment of the present invention.

FIG. 2 illustrates an example of the forward air resistance changing unit 9 and the backward air resistance changing unit 11 in FIG. 1 changing the air resistance.

FIG. 3 shows another example of the flight device with the wing 13 in FIG. 1 of different positions and shapes.

FIG. 4 shows an example where the wing 13 in FIG. 1 is put in.

FIG. 5 illustrates an example of the forward air resistance changing unit 9 in FIG. 1 changing the positions and the shapes while receiving following winds.

FIG. 6 illustrates an example of the forward air resistance changing unit 9 in FIG. 1 changing the positions and the shapes while receiving headwinds.

FIG. 7 illustrates an example showing that the wing 13 utilizes lift force L.

FIG. 8 illustrates an example of controlling the position of the wing 13 in case of FIG. 7.

FIG. 9 illustrates an example of the forward air resistance changing unit 9 in FIG. 1 changing the positions and the shapes to utilize the wind from above.

FIG. 10 illustrates an example of the case where the air resistance at the backward air resistance changing unit 11 is increased to decrease traveling speed.

FIG. 11 illustrates an example of the case where the balance of right-and-left air resistance at the backward air resistance changing unit 11 is changed to change traveling direction.

FIG. 12 is a block diagram of an example of the flight device 1 of the embodiment of the present invention, including server 39 and network 41.

FIG. 13 is a flow chart of prediction process by the prediction device 6 in FIG. 1.

FIG. 14 illustrates the relationship between the current position Py and the target point Pt of the flight device 1 in FIG. 1 and the altitudes and measured values at a plurality of measurement points which the prediction device 6 in FIG. 1 refers to.

FIG. 15 illustrates the relationship between the current position Py and the predicted positions of 5 and 10 minutes later Py(1) and Py(2) of the flight device 1 in FIG. 1.

FIG. 16 illustrates the relationship between the current position Py of the flight device 1 in FIG. 1 and the measurement points P1, P4 and P5.

### DESCRIPTION OF EMBODIMENTS

The following describes embodiments of the present invention with reference to figures. The embodiment of the present invention is not restricted to the following embodiments.

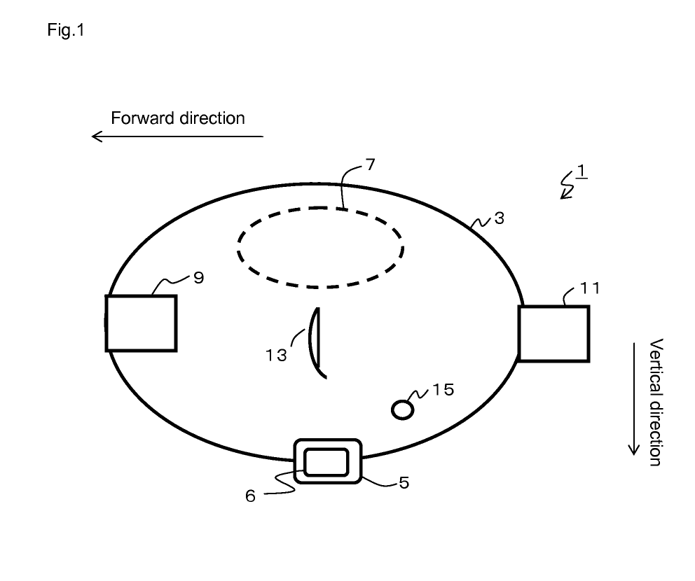

First, referring to FIG. 1, schematic structure of the flight device 1 in accordance with the present invention is described. FIG. 1 is a schematic block diagram of the flight device 1 in accordance with the embodiment of the present invention. The flight device 1 includes a main body 3 (an example of “main body” described in the aspects of the present invention). The flight device 1 includes a controller 5 (an example of “controller” described in the aspects of the present invention) for controlling the behavior and the like of the flight device 1. The controller 5 includes a prediction device 6 for predicting the speed and the direction of the winds in the future and the like based on the speed and the direction of the winds and the like at present.

The main body 3 includes an air sac 7 (an example of “air sac” described in the aspects of the present invention) and an external air gate (an example of “external air gate” described in the aspects of the present invention).

The flight device 1, as well as conventional balloons, can change its altitude by increasing or decreasing buoyant force through adjustment of gas in the air sac 7 with the controller 5. According to a conventional method, for example, it can compress and reduce the air sac which includes helium to decrease buoyant force. Or it can also decrease the gas pressure in the air sac by sucking helium in the air sac using a helium gas cylinder and a gas pump equipped in the air sac. As just described, the flight device can adopt conventional methods to increase or decrease buoyant force. A new method of the present invention to increase or decrease buoyant force will be described below. The conventional method can influence the temperature or air pressure of the air sac, but it does not cause serious problems. Therefore, the air sac 7 can adopt conventional methods to increase or decrease buoyant force and the configuration of the air sac 7 is not restricted.

Further, the flight device can adopt the new method of the present invention to increase or decrease buoyant force using the external air gate 15. The air temperature decreases by about 0.65 degrees centigrade per rise of 100 meters. The method of the present invention to increase or decrease buoyant force of the flight device utilizes the temperature difference between the temperature at low altitude and that at high altitude. The buoyant force is provided by the air sac 7 including helium gas. The magnitude of the buoyant force is equivalent to the weight of the external air of the same volume as the air sac 7, in accordance with Archimedes' principle. Thus, when the air sac 7 is made of soft and flexible material such as plastic and the like, the buoyant force depends on how the air sac 7 is configured.

The volume of the air sac 7 can be configured at least in two types. The first type is such a case where the air sac 7 of 1 m³ is filled under 1 atm with helium gas of 1 m³ under 1 atm (referred to as “type A” in the following). The second type is such a case where the air sac 7 of 2 m³ is filled under 1 atm with helium gas of 1 m³ under 1 atm (referred to as “type B” in the following).

In the case of type A, the buoyant force around the ground under 1 atm is about 1 kg and the buoyant force decreases as the flight device 1 moves upward. For example, at around 3 km above the sea, where the density of the external air decreases by half, the buoyant force is about 0.5 kg.

On the other hand, in the case of type B, the volume of the air sac is 1 m³ under 1 atm and there remains another 1 m³ to expand. The buoyant force around the ground under 1 atm is about 1 kg, too. And at around 3 km above the sea, for example, where the density of the external air decreases by half, the volume of the air sac 7 doubles and amounts to 2 m³, that is, the buoyant force is still 1 kg. The buoyant force does not decrease at around 3 km above the sea. Then, over around 3 km above the sea, because the air sac 7 cannot expand more than 2 m³, the buoyant force becomes smaller than 1 kg as the flight device 1 moves upward. The buoyant force is expressed by the product of the volume of the air sac 7 and the density of the external air. Here, the volume of helium gas in the air sac 7 depends on temperature in accordance with Jacques Charles's law. For example, the temperatures around the ground of 0 m above the sea and the space of about 4 km above the sea differ by about 27 degrees centigrade, which causes about 10% change in volume. Suppose the flight device 1 floating in the space 4 km above the sea keeping the temperature of its air sac 7 at the temperature of 0 m above the sea. Then, if the air sac 7 is exposed to the external air by letting the external air into the main body 3 to chill the air sac 7 by about 27 degrees centigrade, the volume of the air sac 7 of type B shrinks by about 10% and the buoyant force decreases by 10%. On the other hand, suppose the flight device 1 floating in the space 0 km above the sea keeping the temperature of its air sac 7 at the temperature of 4 km above the sea. Then, if the air sac 7 is exposed to the external air by letting the external air into the main body 3 to warm the air sac 7 by about 27 degrees centigrade, the volume of the air sac 7 of type B expands by about 10% and the buoyant force increases by 10%. As described above, the buoyant force of the flight device 1 can be controlled by keeping or letting in and out the external air in the main body 3 and controlling the temperature of the air sac of type B. Large difference in altitude means large difference in temperature. However, such a large temperature difference is not necessary to utilize this effect. The temperature difference of about 14 degrees centigrade can change buoyant force by about 5%. The surface of the main body 3 including the air sac of type B inside needs the function of insulating to keep temperature to some extent. Highly efficient function of insulating can realize big change in buoyant force when the external air is let in and kept in the main body 3. Therefore, the flight device 1 should be designed taking its insulating characteristic into consideration.

The flight device of the present invention does not need its own driving force. It can travel basically utilizing winds and the increase or decrease of buoyant force. Therefore, the use of other energy for traveling can be minimized.

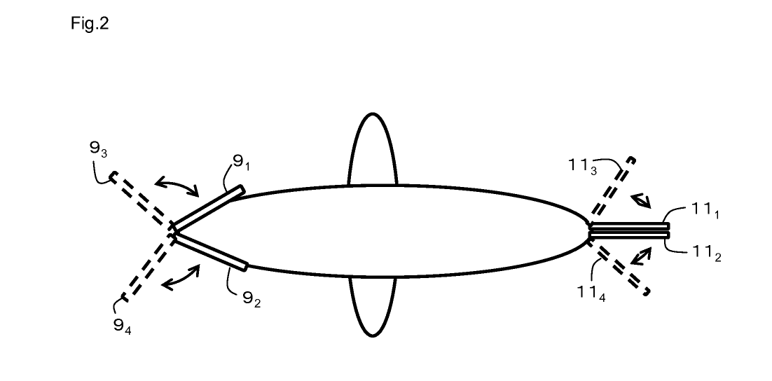

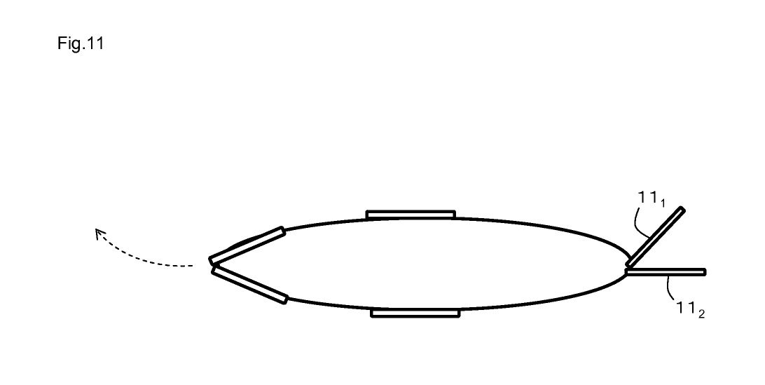

The flight device 1 includes a forward air resistance changing unit 9 (an example of “forward air resistance changing unit” described in the aspects of the present invention) that lies anterior to the main body 3 in traveling direction (leftward in FIG. 1) and a backward air resistance changing unit 11 (an example of “backward air resistance changing unit” described in the aspects of the present invention) that lies in the opposite side (posterior) of the main body 3. The forward air resistance changing unit 9 can be controlled by the controller 5 to change the air resistance in traveling direction and vertical direction. The backward air resistance changing unit 11 can be controlled by the controller 5 to change the air resistance in traveling direction. In this embodiment, as shown in FIG. 2, two platy members are controlled to change air resistance by changing their angles to forward traveling direction and/or vertical direction. The forward air resistance changing unit 9 is controlled to be plane-symmetric with respect to the plane determined with forward traveling direction and vertical direction in order to keep the posture of the flight device 1. The backward air resistance changing unit 11 is controlled to be plane-symmetric with respect to the plane determined with forward traveling direction and vertical direction in order to slow down the flight device 1 as well as to keep the posture. It can be also controlled to be asymmetric with respect to the plane determined with forward traveling direction and vertical direction to form another angle to forward traveling direction in order to adjust the forward traveling direction, as shown in FIG. 11. The flight device of the present invention is not restricted to the above-described shapes or controls. The forward air resistance changing unit 9 may also be controlled to be asymmetric with respect to the plane in order to support the adjustment of the forward traveling direction.

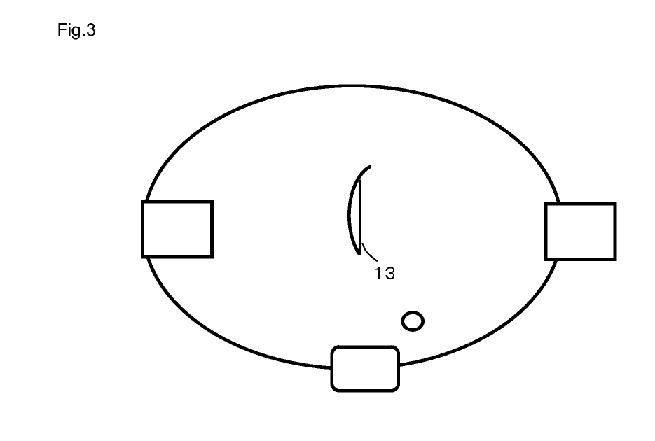

The flight device 1 includes a wing 13 (an example of “wing” described in the aspects of the present invention). The position and/or shape of the wing 13 are changed by control of the controller 5. The shape of the wing 13 is controlled to be convex forward with its anterior part upward when traveling upward, as shown in FIG. 1. And it is controlled to be convex forward with its anterior part downward when traveling downward, as shown in FIG. 3. In this way, forward driving force is gained from the vertical movement of external air. In traveling along following winds or against headwinds, the wing 13 is put in not to interfere the traveling. Here, the shapes of wings of jet airplanes are different under the control of pilots between when taking off and when flying at a high altitude. Similarly, the wing 13 may be a pair of wings configured to be transposable. Or the wing 13 may be configured to be a plurality of wings with different shapes which are selected accordingly.

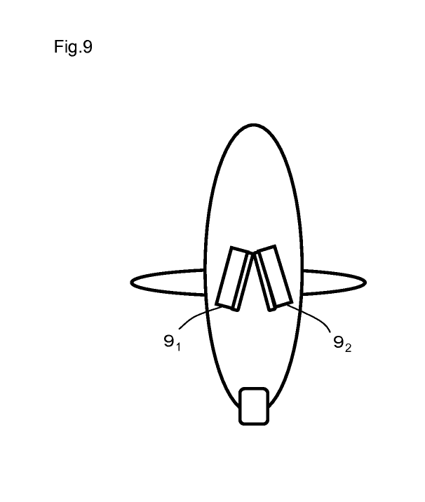

Next, referring to FIG. 2, the forward air resistance changing unit 9 and the backward air resistance changing unit 11 in FIG. 1 are explained. FIG. 2 shows a schematic view of the flight device 1 of FIG. 1 seen from the above. In this embodiment, the forward air resistance changing unit 9 has two air resistance members 9₁ and 9₂. The air resistance member 9₁ can be controlled to change its angle to the forward traveling direction. It can be controlled to change its position from 9₁ to 9₃, for example. The air resistance member 9₂ can be controlled similarly to change its position from 9₂ to 9₄, for example. Their angles to vertical direction can be also changed as shown in FIG. 9. The backward air resistance changing unit 11 also has two air resistance members 11₁ and 11₂. The air resistance members 11₁ and 11₂ can be also controlled to change their angles to the forward traveling direction. Their positions can be controlled from 11₁ to 11₃ and from 11₂ to 11₄, respectively, for example.

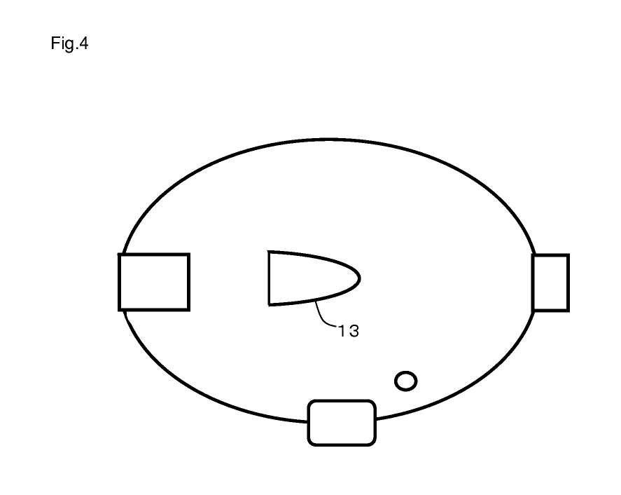

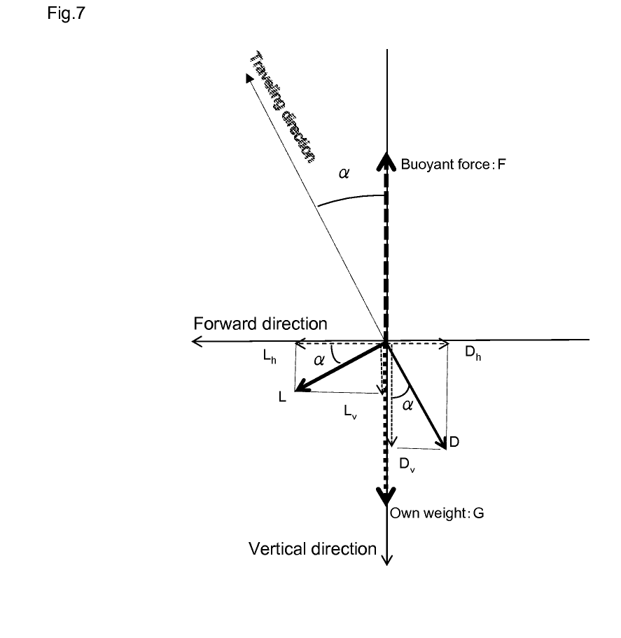

Next, referring to FIGS. 1, 3 and 4, the wing 13 is explained. The flight device 1 can change its altitude by adjusting buoyant force provided by the air sac 7 even in calm. Then, the flight device 1 receives vertical movement of external air (wind). The wing 13 can utilize such a vertical wind and gain driving force. Gaining driving force will be explained in detail later, referring to FIG. 7.

While the flight device 1 is moving upward in calm or in a horizontal airstream, downward wind blows. Shown in FIG. 1 is an example of the position and the shape of the wing 13 in such a case. The controller 5 controls the angle of the wing 13 to control the position of the wing 13 based on the current traveling direction, traveling speed, the magnitude of the buoyant force or the magnitude of driving force, for example. When utilizing the downward wind, the shape of the wing 13 is convex forward and the wing 13 is directed upward. Here, the shape of the wing 13 may be whatever as long as the lift force occurs toward an adequate direction. For example, the shape of the wing 13 may be symmetrical and its shape may not be controlled to adjust to which direction or how it is convex.

While the flight device 1 is moving downward, upward wind blows. Shown in FIG. 3 is an example of the position and the shape of the wing 13 in such a case. The controller 5 controls the angle of the wing 13 and controls the position of the wing 13. In FIG. 3, the wing 13 is formed as convex forward with its anterior part downward.

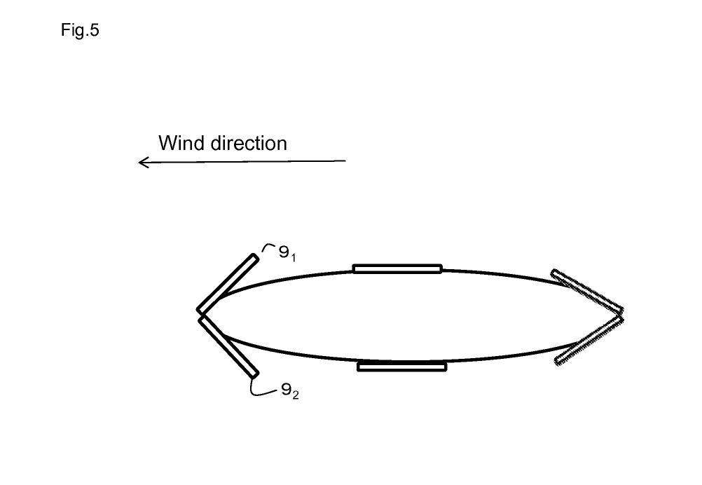

While the flight device 1 stays at an altitude, no vertical wind occurs. In such a case, the wing 13 is only increasing air resistance. Thus, when driving force is not obtained or the obtained driving force is smaller than the air resistance occurred from the wing 13, the controller 5 controls the wing 13 to be in horizontal posture or to be put in. The flight device 1 with its wings 13 put in, seen from the above, is shown in FIGS. 5, 6, 10 and 11. The flight device 1 with its wings 13 spread out, seen from the above, is shown in FIG. 2. The flight device 1 with its wings 13 spread out, seen from the forward, is shown in FIG. 9.

While vertical wind blows hard enough to the flight device 1, the flight device 1 may keep its altitude or gain driving force with the wing 13.

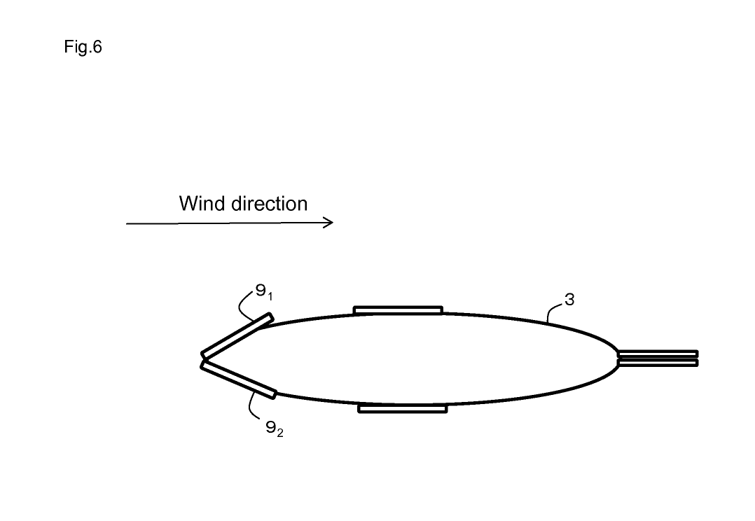

Next, referring to FIGS. 5 and 6, the control of the air resistance members 9₁ and 9₂ is explained.

FIG. 5 illustrates an example of the positions of the air resistance members 9₁ and 9₂ when the flight device 1 receives following wind. The flight device 1 does not need to utilize its own driving force. Thus, the speed of the airstream can exceed the traveling speed of the flight device, which means the flight device 1 receives following wind. In the following wind, the controller 5 changes the position of the forward air resistance changing unit 9 to form a larger angle to the traveling direction than that of FIG. 6 in order to receive more following wind. Then, the forward air resistance changing unit 9 functions as a sail and gains driving force to pull the main body 3 keeping its posture. It should be noted that the angle of the air resistance members 9₁ and 9₂ should be small right after riding on a following airstream not to receive too much driving force from the large difference in speed between the flight device 1 and the airstream. The angle can be larger little by little as the traveling speed of the flight device 1 approaches the speed of the airstream. The backward air resistance changing unit 11 and wings 13 are folded and closely attached to the main body 3 in order to decrease the air resistance from the following wind. In this way, stable forward traveling at the same speed toward the same direction with the airstream is realized as the forward air resistance changing unit 9 receives the driving force of wind. Therefore, the flight device 1 can travel at low cost in an airstream toward the destination without its own driving force.

FIG. 6 illustrates an example of the positions of the air resistance members 9₁ and 9₂ when the flight device receives headwind. The flight device 1 receives headwind when, for example, it rides off a high-speed following airstream, as in FIG. 5, and rides on a lower-speed airstream with a large kinetic energy obtained in the high-speed airstream, or travels against the airstream direction. In headwind, the controller 5 controls the backward air resistance changing unit 11 to decrease the air resistance against forward direction. The wing 13 and the forward air resistance changing unit 9 are folded and closely attached to the main body 3. In this way, the flight device 1 can travel in an inertial motion with the obtained forward driving force. Here, it is possible to decrease the forward air resistance by, for example, sticking straight out the air resistance members 9₁ and 9₂. However, to position there, the air resistance members 9₁ and 9₂ need to be swung against the headwind. Thus, the closely attached position is shown in FIG. 6 in order to decrease the forward air resistance. In addition, when the flight device travels with its own equipped driving force, it receives headwind. Further, in this embodiment, the air resistance members 9₁ and 9₂ are depicted as platy shape. However, the number or the shape of the air resistance members are not restricted as long as the shape is not largely affected by winds and the air resistance values are controlled quantitatively with enough repeatability. For example, the shape may be curved to fit more closely to the surface of the main body 3. Or the number of the air resistance members 9₁ and 9₂ may be more than two.

Subsequently, referring to FIGS. 7, 8 and 9, gaining driving force from vertical winds using wing 13 in FIG. 1 is explained in detail. Here, the driving force is gained from a downward wind occurring when moving upward by increasing buoyant force of the air sac 7 in calm (for example, a case where the traveling speed of the flight device 1 is equivalent to the speed of an airstream). So to say, the potential energy based on buoyant force is transformed into the forward kinetic energy. The driving force can be gained from an upward wind, too. In that case, normal potential energy is transformed into the kinetic energy in a similar way.

The forward direction and the vertical direction in FIG. 7 are the same as in FIG. 1. The gravity based on its own weight G is applied to the flight device 1. Buoyant force F is applied to the air sac 7. In order to gain further driving force, the controller 5 makes the buoyant force F of the air sac 7 larger than the own weight G and the flight device 1 moves upward. Then, the downward wind occurs. At the same time, the flight device 1 receives drag D and lift force L because it travels against air.

Drag D is generally expressed by a mathematical model of eq (1). Lift force L is generally expressed by a mathematical model of eq (2). Among the components of the force applied to the object moving in the air, the component parallel with and the opposite of the moving direction is referred to as drag D, and the component vertical to the moving direction is referred to as lift force L. In this embodiment, the height of the flight device 1 is designed to be near its length, which means the shapes seen from the above and from the front are alike.

In eq (1) and eq (2), p is density of fluid (for example, 1.2250 kg/m³ for the air at the sea level at 15 degrees centigrade), V is relative velocity between the object and the fluid, and S is area of the object. In eq (1), D is incurred drag, and C_{D} is drag coefficient which depends on the shape and the elevation angle of the object, the fluid characteristic and so on. In eq (2), L is incurred lift force, and C_{L} is lift force coefficient which depends on the shape and the elevation angle of the object, the fluid characteristic and so on. Because drag and lift force largely depend on the shape and the elevation angle of the flight object and the fluid characteristic, the characteristics of drag and lift force are different values according to flight device and its wing operation according to winds.

Referring to eq (1), an object receives the drag, while moving in the air, in proportion to its area and the square of relative velocity between the object and the air. Thus, in order to travel in the air at a relatively constant speed, the object has to be driven with the driving force as large as and in the opposite direction of this drag. When the driving force is smaller than the drag, the relative velocity between the object and the air becomes smaller and the traveling speed of the object becomes closer to the speed of the air.

Referring to eq (2), lift force is in proportion to the square of the relative velocity of an object and the air. For a normal airplane, lift force is smaller than its own weight when at a low speed during takeoff and landing. Thus, it changes its shape and the like to increase lift force even at a low speed to balance the lift force and its own weight. In this embodiment, the wing 13 may be designed based on the case where vertical wind speed is low. Then, by adopting a simple configuration, a certain level of lift force can be caused even when the flight device 1 travels at lower speed than when it travels horizontally.

$$\begin{matrix}[ Equation 1 ] & \\ D = \frac{1}{2} ρ {V}^{2} {SC}_{D} & ( 1 ) \\ L = \frac{1}{2} ρ {V}^{2} {SC}_{L} & ( 2 )\end{matrix}$$

Referring to FIG. 7, suppose that the flight device 1 is traveling forward at a speed of V and upward at an angle of α. In this case, applied forces to the flight device are buoyant force F upward, its own weight G downward, drag D in the opposite direction of the traveling direction and lift force L downward vertically to the traveling direction. Thus, the forces are applied forward by the magnitude of (L cos(α)−D sin(α)) and upward by the magnitude of (F−G−L sin(α)−D cos(α)). The negative value of (L cos(α)−D sin(α)) means breaking force against traveling forward. However, because drag D and lift force L becomes smaller as the traveling speed V becomes smaller, drag D becomes 0 before the flight device 1 starts to travel backward. And the negative value of (F−G−L sin(α)−D cos(α)) means slowing down of the upward speed. However, because drag D and lift force L becomes smaller as the traveling speed V becomes smaller, the flight device 1 moves upward at least until the altitude where buoyant force and its own weight balance.

While a normal airplane travels forward horizontally at the speed of V in the air, the air flows relatively in the opposite direction of the traveling direction of the airplane at the speed of V. The airplane receives the drag expressed by eq (1) when traveling forward at the constant speed of V. The airplane balances the drag and the driving force which directs to the opposite direction of the drag, gained from its propeller. Further, the airplane receives the lift force expressed by eq (2) from the wind. The lift force applied to the airplane balances the weight of the airplane.

The wing 13 in FIG. 1 is similar with a normal airplane in shape but different in direction. The wing of a normal airplane is equipped in horizontal direction and receives the wind from forward to produce upward lift force. The wing 13 in FIG. 1 which is similar in shape with the wing of the normal airplane is equipped in vertical direction and receives the wind from upward to produce forward lift force. The flight device 1 travels forward utilizing the lift force as its driving force.

The lift force gained thereby is explained in detail. The buoyant force of the air sac 7 can be increased or decreased by changing the volume of lighter gas than air included in the air sac 7. For example, the increase of the volume of the gas in the air sac 7 by 10% can increase the basic buoyant force applied to the flight device 1 by 10%. Here, it should be noted that the buoyant force is influenced by the density and temperature of the external air depending on altitude. And the volume of the gas lighter than air also depends on altitude. However, it is assumed below for simplicity that the volume is controlled considering the changes of volume and temperature according to altitude and these changes will not be mentioned.

Now, from the initial state where the buoyant force F of the flight device 1 and its own weight G (=Mg, where M is mass of the flight device 1 and g is gravity acceleration (9.8 m/sec)) balances, the volume of the gas in the air sac 7 is increased by 10%. Then, the flight device 1 moves upward with the upward buoyant force larger than its own weight by 0.1 Mg. Because the initial speed is zero and upward speed is low for awhile after takeoff, it is assumed that the whole force of 0.1 Mg works for acceleration. The upward acceleration is 0.1 g as the mass of the flight device 1 is M.

If it reaches about 1225 m above the ground, the amount of time Tⱼ to get there is Tⱼ=(1225/(0.1 g/2))^{0.5} (=about 50 sec). The upward speed V of 50 sec later is, assuming the drag is small enough to be negligible, Vⱼ=50*0.1*9.8 (=about 50 m/sec (176 km/hour)). This speed V has been calculated assuming the drag can be neglected. However, 176 km/hour is such a high-speed that the magnitude of the drag becomes too large to be neglected before the speed amounts to V. Actually, the speed settles down to a lower speed within less than 50 seconds. Thus, in order to realize an upward high-speed, the shape of the flight device should be designed to receive smaller drag by decreasing the upward air resistance. However, practically, Vⱼ is not always necessary. The forward traveling speed realized from just the half of upward speed Vⱼ is useful enough because the forward traveling speed of 18 km/hour is realized from the upward speed of 36 km/hour (=10 m/sec). The upward speed of only 8 km/hour is practical enough because the flight device can travel forward without its own driving force. This upward speed of 8 km/hour (=about 2.2 m/sec) can be very easily realized in about 2.5 seconds after takeoff based on the assumption above.

The upward speed amounts to 36 km/hour at about 490 m above the ground about 10 seconds after takeoff, assuming the drag is negligible because the acceleration is 0.1 g and the upward speed is low for awhile after takeoff. Thereafter, it reaches the altitude of 1225 m about 75 seconds later, even assuming that the upward speed is not accelerated due to the drag and constant at 36 km/hour until it reaches the altitude of 1225 m. That is, the flight device can gain lift force for traveling forward for as long as 75 seconds from the upward movement at the speed of 36 km/hour. Here, actually, the flight device 1 travels forward after takeoff by lift force. The flight device travels at the speed of vector sum of the forward speed and the upward speed. This skew traveling forward and upward means higher speed than upward only traveling. At least, during 75 seconds after 10 seconds later from takeoff, the flight device receives lift force from the upward movement of 36 km/hour and this upward movement of 36 km/hour can be very easily realized.

According to eq (1), the drag D increases in proportion to the square of wind speed. Thus, the drag is small when the flight device 1 receives the wind of low speed. The calculation described above is performed assuming that the drag is small enough until the traveling speed amounts to 36 km/hour. Indeed, it is possible to design the shape of the flight device so that the upward speed becomes constant due to the drag at the speed of about 36 km/hour. Considering that this flight device does not need its own driving force except for human power, even a low speed such as 8 km/hour is practical enough.

A normal airplane receives at least the same amount of lift force as its own weight at the time of takeoff where the speed of the airplane is, say, about 100 km/hour, which is slower than the speed at the time of flying horizontally, say, about 176 km/hour. In other words, the airplane of mass N can receives lift force of Ng at the forward traveling speed of about 100 km/hour. Thus, in this embodiment, the flight device of mass M is designed assuming the wing 13 can receive the similar lift force with that of a normal airplane. The flight device 1 can move upward easily at the speed of 36 km/hour, which is 0.36 times as high as that of the airplane. The lift force is 0.13 (=0.36²) times as large as that of the airplane because lift force is in proportion to the square of speed. That is, the flight device 1 travels forward by the driving force of 0.13 Mg and the acceleration of 0.13 g i.e. 1.27 m/s² (=0.13*9.8). Thus, while the flight device 1 is going upward at the speed of 36 km/hour, it travels forward at the acceleration of about 1.2 m/s² and the forward traveling speed amounts to 12 m/sec (about 43 km/hour) in 10 seconds. Actually, the drag occurs while traveling at such a high-speed and it will take more than 10 seconds to amount to 12 m/sec, which will be realized in less than 20 seconds. Anyway, if not as effective as the wing of the airplane, the forward traveling speed of 12 m/sec can be easily realized in 75 seconds.

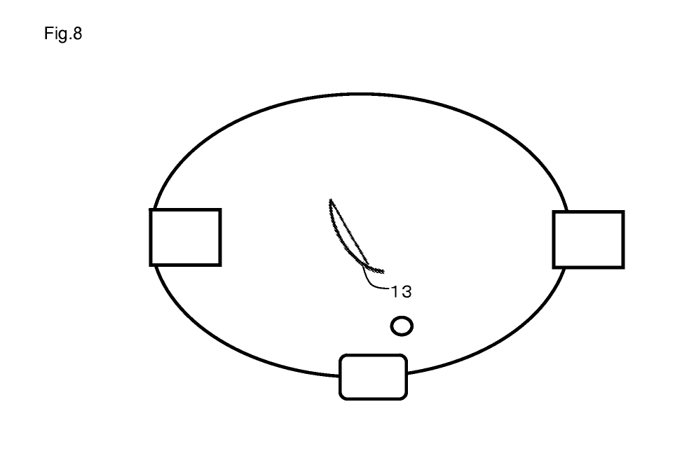

While the flight device 1 is moving upward canceling the drag of air by the buoyant force, it travels forward and upward because the wing 13 receives the forward lift force. As a result, it travels obliquely upward and receives wind from oblique forward. Thus, the wing, which directs upward, receives the wind obliquely. To prevent this happening and let the wing receive the wind adequately, the wing may be rotated obliquely upward according to the wind direction so that it directs parallel to the wind direction as shown in FIG. 8. In this way, by controlling the wing to direct always parallel to the wind direction, the wing always receives small drag and large lift force.

In the embodiment above, the case where in calm is explained as an example. Actually, the obliquely upward angle of the wing is controlled and selected based on the forward traveling speed and the upward moving speed. In the case where an airstream blows from the forward to the backward, the relative wind speed is determined by the speed of the airstream and the forward traveling speed. Thus, the flight device can travel forward stably even in the airstream from forward to backward (in the headwind) by selecting and controlling the tilt of the wing considering the wind speed as the sum of the speed of the airstream and the forward traveling speed. That is, the tilt of the wing should be selected and controlled based on the vector sum of the speed of (the forward traveling speed based on the lift force of the wing+the speed of the airstream) and the upward speed. Here, it should be noted that the substantial forward traveling relative to the ground is possible only in a low-speed airstream because the substantial forward traveling speed is expressed by (the forward traveling speed based on the lift force of the wing−the speed of the airstream).

FIG. 9 illustrates an example of controlling the position of the forward air resistance changing unit 9 seen from forward in FIG. 1 to utilize the wind from above. The angle between the air resistance members 9₁ and 9₂ is controlled to decrease the upward air resistance as well as the forward air resistance.

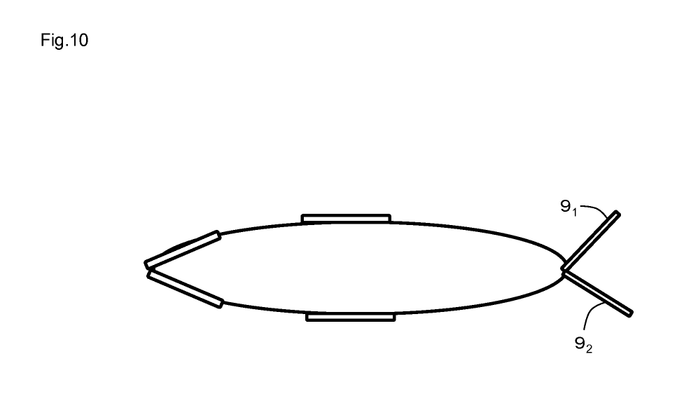

Next, referring to FIGS. 10 and 11, the backward air resistance changing unit 11 in FIG. 1 is explained. The backward air resistance changing unit 11 can function as a brake to decelerate, when receiving headwind and the like, by changing the angles of the air resistance members 11₁ and/or 11₂ to the forward traveling direction to outstretch them and increase the air resistance, as shown in FIG. 10. Besides, it can function to keep the posture of the flight device 1 stable by drawing the flight device 1 backward. Here, the flight device 1 can also spread out the wing 13 to increase the air resistance for deceleration.

Further, as shown in FIG. 11, the backward air resistance changing unit 11 can adjust the traveling direction. This is achieved by adjusting the angles of the air resistance members 11₁ and 11₂ differently, the angles to the forward traveling direction, in order to change the right-and-left air resistance balance. In FIG. 11, the flight device 1 is heading to the right by increasing the air resistance at the air resistance member 11₁ which lies at the right side toward the forward traveling direction. Here, the backward air resistance changing unit 11 maybe configured by a single plate as used for a tail in a normal airplane, in order to function only as a helm.

The backward air resistance changing unit 11 may also receive air resistance from backward, while the forward air resistance changing unit 9 receives following wind, to make it easier to travel with the wind. In this case, to stabilize the posture, it is desirable for the backward air resistance changing unit 11 to receive less air resistance than the main body 3 or the forward air resistance changing unit 9.

In this embodiment, the controller 5 may be configured to load people or light luggage. Then, the crew may handle the air sac 7, the forward air resistance changing unit 9, the backward air resistance changing unit 11 and the wing 13. The configuration for letting the crew handle can be realized without new techniques by one skilled in the art. And to realize the flight device 1 to board a crew and ride on a jet stream or other airstreams at the altitude of about 10 km, the flight device 1 may be equipped with a battery, a simple pressurized cabin and an air conditioner such as a cabin in a jet airplane. It may be also equipped with a solar cell on the main body 3 or the wing 13 to charge the battery.

In this embodiment, the wing 13 needs to function to receive wind and bring about the lift force like the wing of an airplane. However, the shape of the wing 13 maybe any shape as long as it can bring about a certain level of lift force. Besides, the flight device may be equipped with a horizontal tail that can be put in at the rear, though a horizontal tail is not shown in Figures. Also, the forward air resistance changing unit 9 is not restricted to a square shape but may be configured in any shape. And the number of the air resistance members may not be restricted to two but may be three or more. In addition, the forward air resistance changing unit 9 may be platy as shown in Figures or may be curved to fit the surface of the main body 3 better. Further, the forward air resistance changing unit 9 may be equipped to stabilize the posture desirably at a forward extension of a horizontal line almost through the gravity center of the flight device 1. As well, the backward air resistance changing unit 11 may be configured in any shape as long as it functions to control direction and to control air resistance. The backward air resistance changing unit 11 may be equipped to stabilize the posture desirably at a backward extension of a horizontal line almost through the gravity center of the flight device 1, and the position may be other than the bottom of the flight device 1. The air resistance members 9₁ and 9₂ of the forward air resistance changing unit 9 may be configured adhesively or separately.

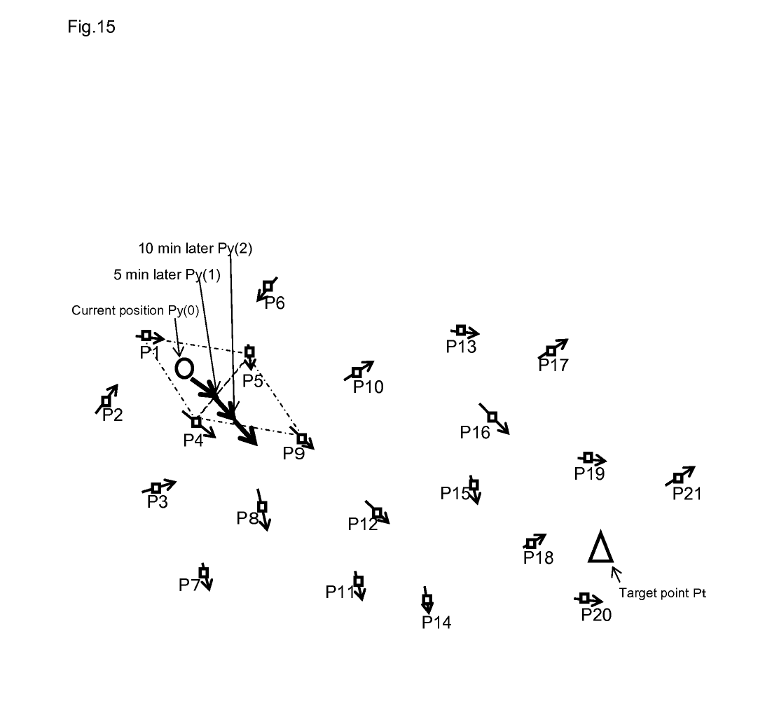

In this embodiment, the method to increase or decrease buoyant force is not restricted and may be any method including conventional methods. In the following, as a part of the present invention, a new useful method applicable almost without physical power from electric energy or fossil fuel and the like is explained. This method is for the flight device equipped with one or more external air gate 15 as shown in FIG. 15 for letting the external air in and out the main body 3. The buoyant force is controlled by adjusting the volume of the air sac 7 through the adjustment of temperature in the air sac 7, which is realized by opening or closing the external air gate 15 to let in or out or keep the external air under the direction of the controller 5. First, the air sac 7 of the flight device 1 is configured as type B described above. The volume of the air sac 7 is configured to realize the buoyant force larger than the own weight of the flight device by 5% up to about 4 km above the sea under the state of atmosphere pressure and temperature of 0 m above the sea. Assuming the own weight of the flight device 1 is Mg, the buoyant force under the state of atmosphere pressure and temperature of 0 m above the sea is about 1.05 Mg. And it is also assumed that the air sac 7 of the flight device 1 is designed so that the buoyant force of the air sac 7 is larger than the own weight of the flight device 1 under the state of atmosphere pressure of 4 km above the sea and the temperature of 0 m above the sea and that the buoyant force balances gravity force because of the decrease of the external air density at 4.5 km above the sea, for example. Initially, the flight device floats at 0 m above the sea keeping the external air of temperature at 0 m above the sea in the main body 3. To go up toward 4 km above the sea, the flight device 1 can gain the buoyant force of 1.05 Mg by opening and closing the external air gate 15 to let in and keep the external air. In order for the flight device floating at 4 km above the sea to go down toward 0 m above the sea, it may similarly open and close the external air gate 15 to let in and keep the cold external air. Then, the air temperature around the air sac 7 decreases by about 27 degrees centigrade, the volume of the air sac 7 decreases by 10%, the buoyant force is reduced to about 0.95 Mg, and the flight device 1 starts to move downward to 0 m above the sea. Needless to say, the flight device 1 can ride on an airstream at any intermediate altitude by opening and closing the external air gate 15 to let in and keep the external air and adjusting the temperature. The flight device 1 can also freely move upward or downward or keep its altitude by adding the buoyant force as a part of lift force gained from receiving the wind through the control of the direction of the wing. The method of increasing or decreasing the buoyant force in case of type B can be applied together with the method in case of type A or conventional method to increase or decrease buoyant force in order to realize a more advanced method to control altitude of the flight device.

Further in this embodiment, the flight device 1 may be equipped with a driving device such as a motorized propeller which may be controlled by the controller 5. The flight device may be equipped with a plurality of the driving devices, for example, at right and left sides. Then, the flight device can change its traveling direction by rotating only one side propeller or travel forward by rotating the both propellers. When traveling with an airstream, the flight device can travel faster at the speed of the sum of the speed of the airstream and the driving speed. By choosing a high-speed airstream, it can travel at the speed of the sum of the driving speed of the flight device and the high-speed of the airstream, leading to such a high-speed traveling that a conventional airship cannot realize. In addition, by traveling with an airstream, less fuel is necessary for traveling, resulting in an ecological traveling.

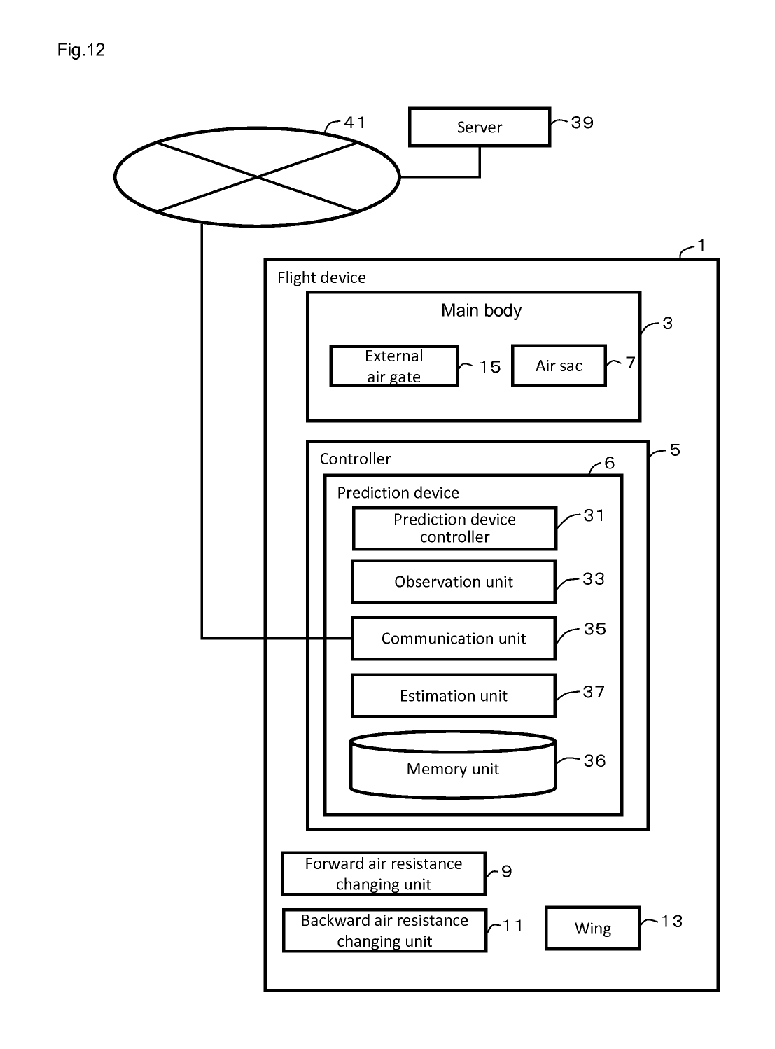

In the following, referring to FIGS. 12 to 16, the prediction device 6 in FIG. 1 is explained. The prediction device 6 predicts the wind direction to the flight device 1 based on the traveling direction of the flight device, the measurement results of wind direction at the altitude of the flight device, and so on. The controller 5 controls, when the prediction device 6 predicts the change of wind direction, to change the air resistance at the forward air resistance changing unit 9 and the like.

FIG. 12 is a schematic block diagram of the whole configuration of the present embodiment. The same with FIG. 1 are the flight device 1, the main body 3, the controller 5, the prediction device 6, the air sac 7, the forward air resistance changing unit 9, the backward air resistance changing unit 11, the wing 13, and the external air gate 15. The prediction device 6 includes a prediction device controller 31, an observation unit 33, a communication unit 35, a memory unit 36 and an estimation unit 37.

The prediction device controller 31 controls the whole behavior of the prediction device 6.

The observation unit 33 includes a GPS (Global Positioning System) and a wind profiler. The observation unit 33 observes the current positional information of the flight device 1 using GPS and gain the traveling direction, speed, acceleration and the like of the flight device 1. The observation unit 33 observes the real-time measurement information of the direction and the speed of airstreams within the observable range (for example, within the spherical space of about 10 km from the current position) using the wind profiler. In the following, the data obtained by the observation of the observation unit 33 is referred to as “observation data.” The observation data includes the data of the direction and the speed of winds. The prediction device controller 31 may indicate the observation data together with the current position on the map in a display, not shown in the Figures. Then, a crew can choose and ride on an adequate airstream or wind for traveling toward the destination referring to the airstream or its speed displayed.

The communication unit 35 receives meteorological data, including the data of airstreams, from a server 39 via network 41. An example of the server 39 is a weather information server of Meteorological Agency. Airstreams are measured at regular points and at regular intervals at meteorological observatory and at airports, for example, for now. In the past, measuring instruments only measures the speed and direction of airstreams at the point where it is installed. However, now that wind profilers and the like are developed, recent measuring instruments can measure real-time speed and direction of airstreams at a distant position within about 10 km away from the point where it is installed. Meteorological Agency measures speed and direction of airstreams at particular measuring points almost every hour utilizing such measuring instruments and discloses the measurement information as a part of weather information.

The server 39 may not be restricted to a server one-sidedly broadcasting the meteorological data obtained in an organization such as Meteorological Agency. The server 39 may be operated to gather the observed data in real time observed by observation units of the prediction devices equipped in other flight devices. Such a server can be provided by commercial company corporations as a business. They can operate the server constantly and keep up the basic meteorological data and flow path data collecting membership fee from their clients, the owners of flight devices and so on. And in addition to providing constantly the meteorological data and observation data according to the demand of their clients, they can receive constantly (every 5 minutes, for example) the observation data from the clients' flight devices and memorize and manage the data. In this way, although such an organization as Meteorological Agency updates meteorological data of particular points every 1 hour, accurate prediction is realized based on more real-time data which is received from and obtained by a number of flight devices traveling in real time. Thus, as the more flight devices utilize the data in the server and transmit and update the observation data to the server, the more information the server can gather. Then, the server becomes more useful for other flight devices, which will still increase the number of users.

The communication unit 35 downloads basic meteorological data such as direction and speed of airstreams and their change at the space where the observation unit 33 cannot observe (out of about 10 km away, for example) from the server 39. The example of the network 41 is the Internet. The meteorological data which is observable from the observation unit 33 may be also downloaded and compared with the observation data to deal with (modify, for example) the meteorological data of the space not observable.

The flight device 1 may not be equipped with the observation unit 33. Then, the communication unit 35 may receive all the information from the server 39. However, the meteorological data is the weather information of the airstreams at about 100 points in Japan. This meteorological data indicates only the speed and directions of airstreams within about 10 km away from each of the measurement points. It is like driving a car knowing width and direction of roads here and there discretely but not knowing how the roads connect to each other. A wind profiler can provide the information of airstreams within about 10 km away from the current position of the flight device 1. If a car driver knows the roads well enough, the driver would not need a map or a headlight during the daytime. However, airstreams are always changing and they change a lot after a day. Thus, the meteorological data of airstreams and the function of the wind profiler to know airstreams are useful. Additionally, Meteorological Agency provides only the weather information of airstreams up to 9 km above the sea of measurement points in Japan but it does not provide the information of the airstreams at higher altitudes for now. Besides, little information of the airstreams abroad is disclosed. So, for now, the function of the wind profiler to know the information of airstreams near the current position is helpful for the flight device 1.

The memory unit 36 stores data of airstreams information such as airstreams information at altitudes of each of measurement points Pᵢ (i is an integer), the meteorological data of airstream information and the like. It also stores the information previously received as archival record. It also stores the observation data observed by the observation unit 33 and calculation results. Further, it also stores amount of time required to change altitudes which depends on the performance of flight devices, the traveling speed of flight devices while riding on airstreams (for example, the maximum speed of 90 km/hour while riding on the airstream of 100 km/hour) and so on.

The estimation unit 37 estimates the direction and speed of winds at any spatial point in the future and the traveling route of the flight device 1, based on meteorological data, observation data and so on stored in the memory unit 36.

Conventional balloons and airships cannot ride on high-speed airstreams stably, though they can ride on a soft airstream. A normal balloon unstably rotates on a high-speed airstream especially one including a turbulence because the air resistance of a balloon is almost isotropic horizontally. And an airship will make a right-about-turn when receiving a following wind and travels backward (with its bottom directed to the traveling forward direction) because it is configured to decrease the air resistance of headwind. And when it rides off the airstream, it is still traveling backward and easy to lose its posture by receiving the wind from its bottom. Most of high-speed airstreams blow at 7 km above the sea or higher. Thus, boarding on a flight device is difficult if its controller does not have any protection against low atmospheric pressure and low temperature. As a result, it is difficult to travel riding on a high-speed airstream on a conventional balloon or an airship even if equipped with an airstream observation unit. Besides, without prediction device for estimating and riding on and off airstreams, it is difficult to travel, especially changing altitudes, toward the destination riding on a high-speed airstream.

The flight device 1 of this embodiment can keep its posture stable despite wind directions. And it can gain the driving force by changing its altitude and choose an adequate airstream to utilize. Thus, by obtaining the airstream information of the whole country using the observation unit 33 and the communication unit 35, it can choose not only the airstreams near its current position but also the airstreams on the way to the destination and travel effectively. Particularly, it can choose the route which may be a roundabout but in which it can change airstreams easily on the way and travel within a shorter time and at a smaller amount of energy.

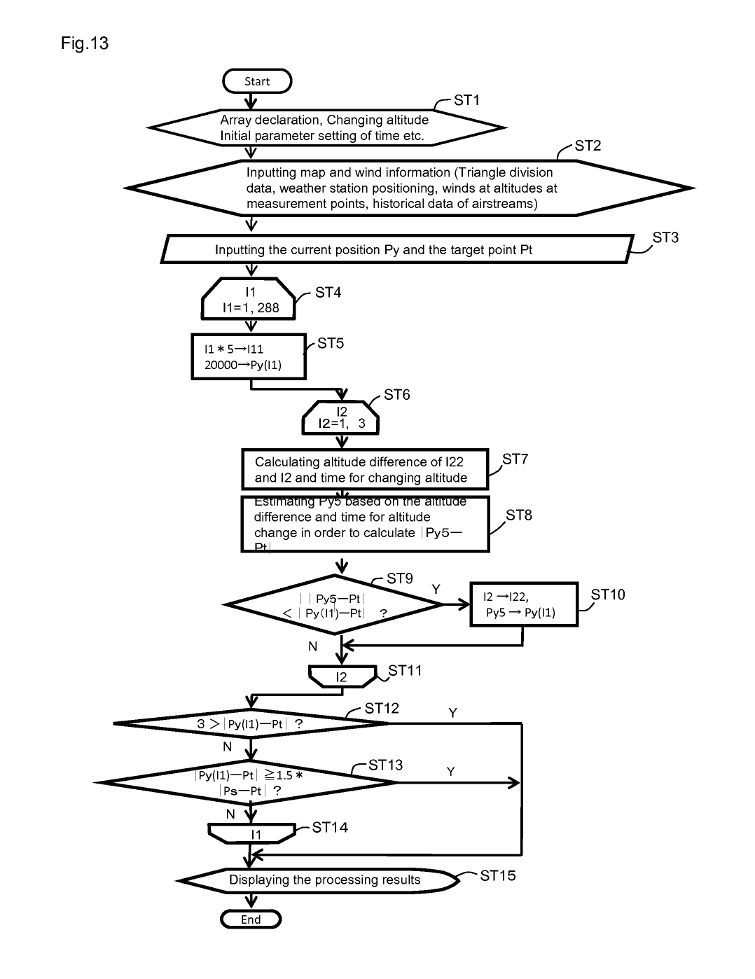

Next, referring to FIGS. 13 to 16, information processing to predict airstreams based on observation data and meteorological data, for obtaining more information of airstreams, and to determine the adequate candidate route of airstreams to ride on and off from a predetermined spatial point of the flight device (a current position or another starting point, for example) to the destination are explained in detail.

Airstreams vary depending on the altitude from the ground and the weather condition which varies over time. Over 7 km above the ground, there are pluralities of global stable airstreams such as jet streams whose paths do not change day by day, though they change in a long term. The speed of a jet stream can exceed 360 km/hour. At altitudes of about 7 km above the ground or lower, there are the airstreams which are slower than about 300 km/hour but stable in direction and speed during about an hour as measured with wind profilers and informed via Internet by Meteorological Agency. Also at altitudes of 3 km above the ground or lower, there are airstreams of about 36 km/hour almost always anywhere in Japan.

There are various kinds of stable airstreams. For example, there are airstreams such as jet streams at about 10 km above the ground which change its path month by month but almost always flow in the same direction during a day. Some of them flow as fast as at about 100 m/sec (about 360 km/hour). And there are winds such as sea breezes or land breezes which blow at certain time every day, and its speed is about 10 m/s (about 36 km/hour).

And there are various kinds of unstable airstreams. For example, typhoons occur in a particular season and move for some days changing its speed and direction. Additionally, there are airstreams which flow at about 10 m/sec or slower and change its direction day by day according to pressure pattern. A space where the airstreams of about 100 m/sec blow and a calm space do not contact each other. Between them, there is a space where airstreams of intermediate speeds of 10 m/sec, 20 m/sec, . . . , and 100 m/sec flow gradationally. Meanwhile, there are meteorological phenomena such as tornados where winds of different speeds blow gradationally indeed but so closely that they appear to blow spatially disconnectedly from the around space.

At the altitude of 7 km above the ground, a conventional flight device without its own driving force hardly travel because the air density is too thin to gain buoyant force and the temperature is low. However, the flight device of the present invention can easily travel by choosing adequate airstreams toward the destination and riding on the airstreams stably utilizing the forward air resistance changing unit 9. Therefore, it can travel on the path of airstreams almost as fast as the airstreams without its own driving force. Particularly, near seaside where sea breezes or land breezes blow stably in direction, it can travel utilizing them if their blowing directions are almost identical with the direction toward the destination.

The traveling method utilizing the forward air resistance changing unit 9 is basically not adopted when airstreams do not blow toward the destination. Here, the airstreams from up in the air to near the ground blow almost in the same directions in most cases. However, the airstreams up in the air and near the ground often blow in different directions almost by 90 degree and sometimes in the opposite directions. Thus, even if an airstream blows away from the destination at the starting point, it is possible to travel toward the destination after a shortly roundabout trip which leads to a point where an airstream blows toward the destination. In addition, in this embodiment, it can travel more effectively with the driving force gained utilizing wing 13 than by only riding on airstreams. Besides, it is also possible to detect the airstream in any direction after detecting for some days. Therefore, the flight device can utilize an adequate airstream path for a predetermined object without difficulty especially when a little different angle of direction of the airstream from the desired direction is not a serious problem.

The object of the information processing is to display some airstream routes which can be utilized from the starting point Ps (=Py(0)) where the flight device 1 starts to ride on an airstream to the destination (the target point Pt). An airstream may not blow from the starting point Ps to the target point Pt. There may be only the airstream blowing away from the target point and it may be impossible to travel sometimes. Then, the flight device has to stay or travel with the driving force without using airstreams. Prediction device 6 makes it possible to display information for determining selectable airstream candidates if there are airstreams which can be utilized. The controller 5 controls, referring to the paths of airstreams which can be utilized, based on the airstream route which includes some of the airstreams. Utilizing the information processing program, it is possible to change airstreams traveling from the starting point Ps to the target point Pt on the airstream route which are composed of many selected airstreams.

The flight device may ride on and off airstreams so often that, in this embodiment, it is assumed that it may ride on and off airstreams every 5 minutes. And it is assumed that the flight device chooses the best altitude toward the target point and travels there, based on the calculation of the positions (Py(1)) of 5 minutes later in case of riding on the airstreams at a plurality of altitudes including the current altitude. The traveling route can be obtained by calculating the positions (Py(2)) of 10 minutes later and the like. When the flight device approaches within 3 km away from the target point Pt, the calculation is finished and the route is displayed. Calculating the candidate route, if the distance between the intermediate position and the target point Pt is 1.5 times as far as the distance between the starting point and the target point Pt or farther, the calculation is finished because it is difficult to approach the target point Pt by this route and display the route. Here, the routes toward the target point Pt during the previous day may be displayed for reference. And according to the desire by users, the history of traveling routes from the starting point Ps to the target point Pt by flight devices of the past may be referred.

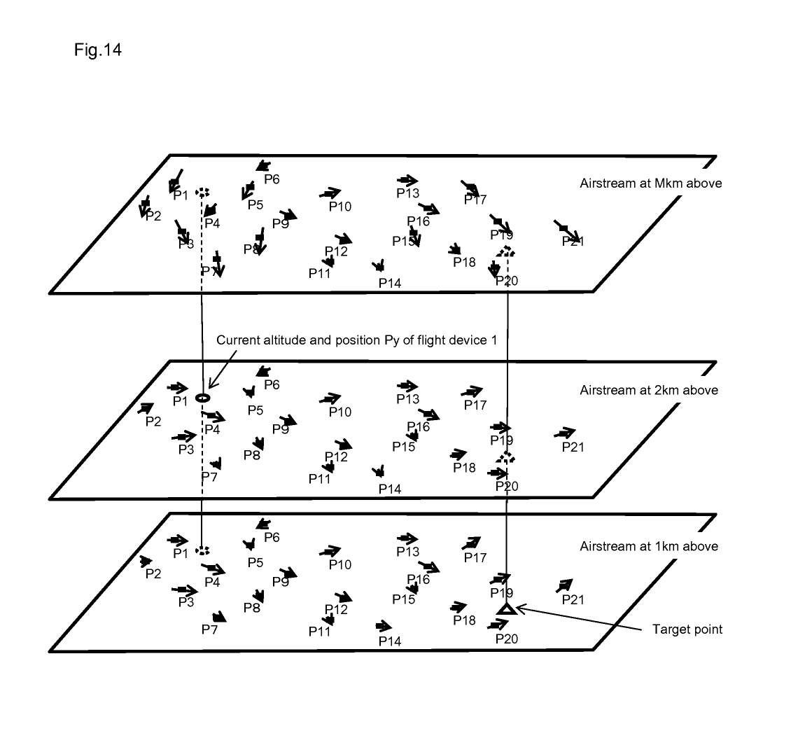

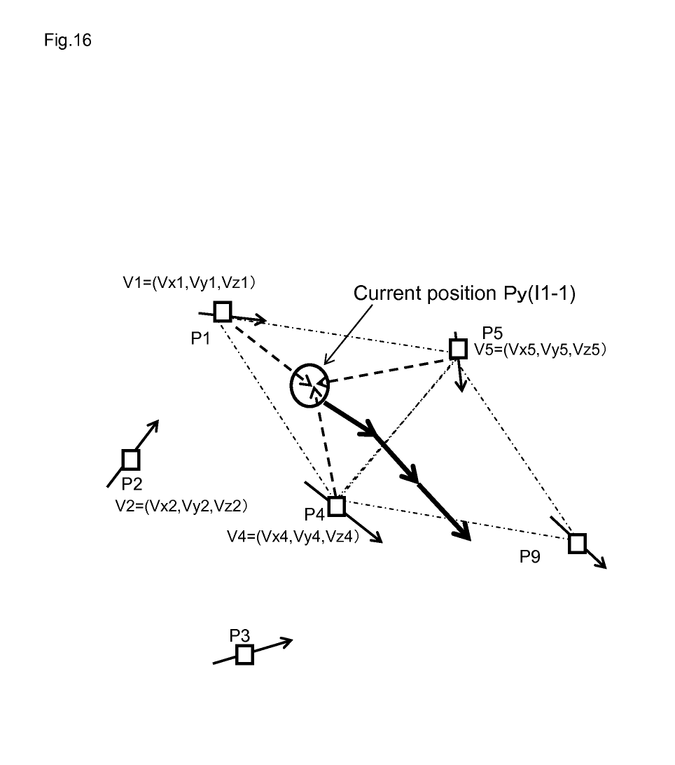

FIG. 13 is a flow chart showing the information processing by a computer to calculate an airstream path based on the information, obtained from meteorological data and measurement data, on speed and direction of airstreams of each layer up in the air at some measurement points. FIG. 14 illustrates an example of displaying speed and direction of airstreams at each measurement point Pi (ith measurement point). FIG. 15 illustrates an example of displaying speed and direction of airstreams of each layer at several altitudes at a measurement point. FIG. 16 illustrates an example of displaying speed and direction of airstreams of each layer at several altitudes at a measurement point and predicting the traveling 5 and 10 minutes later of the flight device 1.

Referring to FIG. 13, an example of information processing using program is explained. The prediction device controller 31 declares an array, replace variables by observed values observed by the observation unit 33, or set parameters such as an initial value of necessary amount of time for changing altitudes, performance value of the flight device and so on (step ST1).

Subsequently, the prediction device controller 31 generates a data on map information and wind information, based on the data stored in the memory unit 36 (step ST2).

The data on map information includes, for example, normal map data, latitude, longitude, landscape, rivers, administrative districts, names of municipality, roads, buildings, triangle division data of districts, and positioning data of meteorological weather stations. Here, the triangle division data of districts is the data of districts where flight devices can travel divided into triangles whose vertices are the measurement points. Any point lies within any one of the triangle divisions. Of course, some districts such as islands or seasides have few measurement points in their neighborhoods and if there are only one or two measurement points, such districts cannot be surrounded by triangles. In such cases, the data measured at the near measurement point lately may be utilized without modification. For example, as shown in FIG. 14, suppose the current altitude of the flight device 1 is 2 km above the ground and the altitude of the target point Pt is 1 km above the ground. Referring to FIG. 15, the starting point Py(0) is surrounded by three measurement points P1, P4 and P5. The data of wind information at each measurement point Pi includes, for example, wind information at altitudes above the measurement point, historical data of airstreams information and so on. The speed and direction of airstream at high altitudes at any point is obtained, as expressed by eq (3), by calculating the proportional distributions using the airstream vectors observed at the altitude above the three measurement points, assuming the speed is inversely proportional to the distance from the three measurement points. Here, in eq (3), the number of measurement points is expressed by M (3 in this embodiment). The velocity vector Vm of an airstream at the mth (m is an integer equals to or less than M) point Pm is expressed as Vm=(Vxm, Vym, Vzm), using the expression of velocity component. The coordinate of the position of each spatial point is expressed by positional vector Pm=(Xm, Ym, Zm), assuming, for example, the city hall of Akashi city is set as the original point, and X axis directs to east, Y axis directs to north and Z axis indicates the above sea level. Then, suppose the flight device is traveling at an arbitrary point Py=(Xy, Zy, Zy) with the velocity vector of Vh. In FIG. 16, for example, Py lies within the triangle area surrounded by the points P1, P4 and P5. The velocity vector Vy of an airstream at a point Py can be calculated using eq (3), assuming the airstream speed is inversely proportional to the distance from the vertices. This airstream velocity vector can be calculated for each altitude. The wind vector can be expressed as the difference between the airstream velocity vector Vy and the velocity vector of the flight device, (Vy−Vh). Then, the prediction device controller 31 sets the data of the current position Py(0) of the flight device observed by the observation unit 33 and the data of the target point Pt (step ST3). Starting from the initial position Py(0), after traveling from the initial position for 5 minutes on an airstream at the altitude, the position 5 minutes further later and the airstream vector there are calculated. Then, the nearest altitude to the target point in the route just passed is chosen, and again, the position 5 minutes later is calculated sequentially. The positional vector Py(I1) can be calculated by adding the vector (0.9*5*Vy), which means the movement for 5 minutes, to the current positional vector Py (I1−1), assuming the flight device travels riding on an airstream where the traveling speed of the flight device is 90% of the speed of the airstream.

$${V}_{y} = \frac{1}{3} ( \frac{{V}_{1} \vert {P}_{4} - {P}_{y} \vert + {V}_{4} \vert {P}_{1} - {P}_{y} \vert}{\vert {P}_{4} - {P}_{y} \vert + \vert {P}_{1} - {P}_{y} \vert} + \frac{{V}_{4} \vert {P}_{5} - {P}_{y} \vert + {V}_{5} \vert {P}_{4} - {P}_{y} \vert}{\vert {P}_{5} - {P}_{y} \vert + \vert {P}_{4} - {P}_{y} \vert} + \frac{{V}_{1} \vert {P}_{5} - {P}_{y} \vert + {V}_{5} \vert {P}_{1} - {P}_{y} \vert}{\vert {P}_{5} - {P}_{y} \vert + \vert {P}_{1} - {P}_{y} \vert} ) \qquad ( 3 )$$

The prediction device controller 31 repeats the procedure from step ST5 to step ST 13 by incrementing the value of variable 11 from 1 to 288, that is, from 5 minutes later to 24 hours later, assuming the calculation is repeated every 5 minutes. The number 5 times as large as I1 is set to I11, the variable of elapsed time, and as an initial value to Py(I1), the variable of traveling distance, 20000 is set indicating the opposite side of the earth, far away enough (step ST5).

Subsequently, the prediction device controller 31 changes the value of variable I2 according to the current altitude and repeats the procedure from step ST7 to step ST 10 (step ST6 and step ST11). Here, the variable I2 is incremented from 1 to 3 because it is assumed that the flight device travels at the altitude of 3 km above the ground or lower.

Subsequently, the estimation unit 37 calculates the altitude difference between the altitude I22, the altitude of the starting point, and the altitude I2 and the necessary amount of time for changing altitude (step ST7). Then, the estimation unit 37 estimates the position 5 minutes later Py5 of the flight device 1 based on the calculated altitude and necessary amount of time for changing altitude and calculates the distance to the target point, |Py5−Pt| (step ST8). For example, when the flight device 1 changes its altitude at the position Py(I1−1), the estimation unit 37 considers “it takes 1 minute to change the altitude by 1 km” and estimates the point it reaches 5 minutes later including the necessary amount of time for changing altitudes to change airstreams. The relay position during changing altitudes is estimated based on the speed Vb of the flight device before changing its altitude, the airstream speed Va of the airstream to ride on after changing the altitude and their directions. The calculating formula depends basically on the performance of the flight device. Thus, a general expression is omitted here because the positions to reach are calculated based on Vb, Va and their directions. Then, in case that the flight device change airstreams from a high-speed airstream to a low-speed airstream, for example, assuming the flight device can choose the traveling direction among the angle different from the direction of the low-speed airstream by 45 degrees, it determines the traveling direction toward the target point. The traveling speed decelerates gradually, assuming here the speed slows down to by 5% minute by minute, from 0.95Vb 1 minute later, 0.95²Vb 2 minutes later and so on. If the traveling speed is less than 0.90 times as fast as the low-speed airstream, the speed is regarded as 0.90Va. When the traveling speed comes down to 0.90Va, it travels in the same direction of the low-speed airstream. In case that the flight device change airstreams from a low-speed airstream of the speed of Vb to a high-speed airstream of the speed of Va, the flight device travels in the same direction of the high-speed airstream when riding on the high-speed airstream. And the flight device is accelerated, for example, by 30 km/hour every minute up to 0.90Va. In case that both the traveling speed and the speed of the airstream to ride on are 36 km/hour or less, the flight device may travel vertically toward the target point. Then, because the traveling direction is different from the direction of the airstream, not only the speed of the airstream but also its direction should be taken into consideration. By considering direction of the airstream, the position of the flight device after traveling can be calculated as the vector sum of the positional vector of the flight device before traveling and the traveling velocity vector of the flight device multiplied by the traveling time. The position of the flight device after changing airstreams is calculated assuming the speed and direction of the airstream to which the flight device has changed are kept for 5 minutes, though the necessary amount of time for changing airstreams is subtracted therefrom. When traveling along an airstream, calculation is performed considering whether the traveling direction is the same with or the opposite of the direction of the airstream and the like because the traveling speed can be increased or decreased utilizing the forward air resistance changing unit 9. The altitude where the estimated position 5 minutes later, Py5, is the nearest to the target point among the estimated positions at each altitude is chosen and the nearest Py5 is substituted to the estimated position Py(I1) of the flight device 5 minutes later. For the moment of 5*(I1+1) minutes later, the triangle division where Py(I1) lies is obtained and the similar process is performed.

The estimation unit 37 determines whether the distance |Py5−Pt| is smaller than the previous minimum value of |Py(I1)−Pt| (step ST9). If smaller, I2 and Py5 are substituted into I22 and Py(I1), respectively (step ST10), which are repeated until all the I2 are processed (step ST11). If larger, without substituting, the processes are repeated until all the I2 are processed (step ST11).

The estimation unit 37 determines whether the distance |Py(I1)−Pt| is equals to 3 or less, that is, whether the flight device approaches within 3 km away from the target point (step ST12). If it approaches within 3 km away, the processes of I1 are not repeated and the combination of previously obtained I11 (traveling distance) and Py(I1) (traveling path) are displayed as the route using the airstream to ride on (step ST15). If it does not approach within 3 km away, the estimation unit 37 determines whether the distance from the estimated position Py(I1) to the target point Pt, |Py(I1)−Pt|, is 1.5 times as long as the distance from the starting point Ps to the target point Pt, |Ps−Pt| or longer (step ST13). If 1.5 times as long or longer, it is determined that there is no adequate airstream and the combination of previously obtained I11 and Py(I1) are displayed (step ST15). If less than the 1.5 times, the process is executed for unprocessed I1 (step ST14). If it does not approach within 3 km away after the process is executed for all I1, determining that the destination is so far that it does not reach the target point after riding on airstreams for 24 hours, the combination of previously obtained I11 and Py(I1) are displayed (step ST15).

It is possible to display the airstream route candidates of the next 24 hours by reentering the position where the flight device approached after the previous 24 hours traveling as the new starting point. If the flight device approaches the target point but not get there after the next 24 hours, the airstream route to the target point can be displayed by repeating the reentering of the starting point described above.

The traveling speed when riding on an airstream depends on the performance of flight devices. Here, it is assumed it can travel at 90% as fast as airstreams when riding on airstreams. However, because the traveling speed depends on the performance of flight devices, which should be inputted as initial data. In the above, the positions of the flight device after every 5 minutes are calculated based on the initial position, traveling speed and traveling direction. The traveling speed is assumed to be 90% as fast as airstreams as an example. This ratio of 90% is just an example and depends on the performance of flight devices. In order to calculate accurately, the calculation must be performed based on the performance of each flight device. In addition, in this embodiment, the flight device is assumed to ride on an airstream under 3 km above the ground. However, it is easy to calculate for 12 km above the ground, for example, by replacing the parameter of the performance of the flight device 1. As well, the calculation frequency of 5 minute may be changed. It may be as often as every 1 minute, for example, according to the processing speed of the flight device. Besides, the distance to display the result is not restricted to 3 km away from the destination.

If adequate directions of airstreams are not detected, a different point from the current position may be selected as a starting point to display an airstream route for reference to travel. In this case, the flight device may not travel from the current point to the selected starting point utilizing airstreams. However, it can reach there by utilizing the driving force obtained from adjusting buoyant force.

If the desirable airstreams are not still detected, the state of airstreams in an arbitrary past time point may be displayed, while staying, for planning the future traveling and the like.

The triangle division data of districts is for simple calculation of airstreams at an arbitrary point. Thus, if any other method is available for directly obtaining airstream data of an arbitrary point, such a method may be adopted.

### INDUSTRIAL APPLICABILITY

The flight device of the present invention can detect the direction and speed of airstreams, choose the airstreams toward the destination and travel riding on the airstreams. Therefore, it is realized to travel faster at lower cost. Further, by utilizing the driving function of the wing of the present invention, driving force can be gained without fuel, resulting in faster traveling at lower cost.

### REFERENCE SIGNS LIST

1: Flight device, 3: Main body, 5: Controller, 6: Prediction device, 7: Air sac, 9: Forward air resistance changing unit, 9₁ and 9₂: Air resistance member, 11: Backward air resistance changing unit, 13: Wing, 15: External air gate, 31: Prediction device controller, 33: Observation unit, 35: Communication unit, 36: Memory unit, 37: Estimation unit, 39: Server, 41: Internet

1. A flight device with a main body including an air sac, comprising:
a forward air resistance changing unit that lies anterior to the main body in traveling direction and is controlled by a controller to change air resistance against external air; and
a backward air resistance changing unit that lies posterior to the main body in traveling direction and is controlled by the controller to change air resistance against external air;
wherein the controller controls the forward air resistance changing unit, when the external air moves from forward in traveling direction, to stabilize posture by decreasing air resistance in traveling direction;
the controller controls the forward air resistance changing unit, when the external air moves from backward in traveling direction, to stabilize posture as well as to cause driving force by increasing air resistance in traveling direction and functioning as a sail;
the controller controls the backward air resistance changing unit, when the external air moves from forward in traveling direction and when necessary, to decelerate by increasing air resistance in traveling direction; and
the controller controls the backward air resistance changing unit, when the external air moves from backward in traveling direction, to stabilize posture by decreasing air resistance in traveling direction.

2. The flight device as claimed in claim 1,
wherein the controller controls the backward air resistance changing unit to stabilize posture as well as to adjust traveling speed by increasing the air resistance; and
the controller controls the backward air resistance changing unit to adjust forward traveling direction by changing the balance of right-and-left air resistances in traveling direction.

3. The flight device as claimed in claim 1,
wherein the main body includes a wing whose position and/or shape is changed by control of the controller;
the controller controls buoyant force caused by the air sac to change altitude; and
the controller gives forward driving force to the wing by vertical moving of the external air.

4. The flight device as claimed in claim 1,
wherein the forward air resistance changing unit includes one or more air resistance member; and
the controller controls the air resistance member to increase forward air resistance by increasing angle to forward traveling direction and to decrease forward air resistance by decreasing angle to forward traveling direction.

5. The flight device as claimed in claim 1,
wherein the main body insulates the air sac from the external air outside the flight device to keep temperature of the air sac and includes an external air gate for letting the external air into the main body;
the air sac matches temperature of air inside of the air sac and temperature of the external air let into the main body; and
the controller increases or decreases buoyant force by letting external air in the main body through the external air gate at a certain altitude.

6. A flight device with a main body including an air sac, comprising:
a forward air resistance changing unit that lies anterior to the main body in traveling direction and is controlled by controller to change air resistance against external air; and
a prediction device that predicts relative wind direction of the external air against the flight device based on traveling direction data which indicates traveling direction of the flight device and wind direction data which indicates wind direction at an altitude where the flight device flies;
wherein the controller controls the forward air resistance changing unit, when the external air moves from forward in traveling direction, to stabilize posture by decreasing air resistance in traveling direction;
the controller controls the forward air resistance changing unit, when the external air moves from backward in traveling direction, to stabilize posture as well as to cause driving force by increasing air resistance in traveling direction and functioning as a sail; and
the controller controls the forward air resistance changing unit, when the prediction device predicts change of relative wind direction of the external air, to change air resistance.

7. The flight device as claimed in claim 6,
wherein the prediction device predicts relative wind direction and relative wind speed of the external air against the flight device in a route from a position and an altitude of a spatial point to a position and an altitude of a destination; and
the controller determines a candidate route to a destination by distinguishing relative wind direction of the external air in the route between wind from backward in traveling direction and wind from forward in traveling direction and by analyzing change of traveling speed of the flight device based on changing altitude and on relative wind speed of the external air.
